(19) United States
(12) Patent Application Publication
(10) Pub. No.: US 2025/0040606 A1
(43) Pub. Date: Feb. 6, 2025

(54) METAL HEATING FILM, AND PREPARATION METHOD AND USE THEREOF

(71) Applicant: Hainan Moore Brothers Technology Co., Ltd., Hainan (CN)

(72) Inventors: Hua LIU, Hainan (CN); Yuchao LIAO, Hainan (CN); Hongming ZHOU, Hainan (CN); Xiaofeng LIAO, Hainan (CN); Ziyu WU, Hainan (CN)

(21) Appl. No.: 18/918,933

(22) Filed: Oct. 17, 2024

Related U.S. Application Data
(63) Continuation of application No. PCT/CN2023/081349, filed on Mar. 14, 2023.

(30) Foreign Application Priority Data
Apr. 20, 2022 (CN) 202210420215.3

(51) Int. Cl. A24F 40/46; A24F 40/70; B22F 1/00; B22F 1/10; B22F 7/00; B22F 7/04; B22F 9/08; C22C 19/05

(52) U.S. Cl. CPC A24F 40/46; A24F 40/70; B22F 1/09; B22F 1/10; B22F 7/008; B22F 7/04; B22F 9/082; C22C 19/055; B22F 2009/0824; B22F 2301/15; B22F 2301/25; B22F 2302/256; B22F 2998/10; B22F 2999/00

(57) ABSTRACT

A metal heating film includes: a nickel-chromium-alloy-based metal heating film or a nickel-based metal heating film; and at least one of metal elements Ru, Pt, and Pd. In an embodiment.

### CROSS-REFERENCE TO PRIOR APPLICATION

This application is a continuation of International Patent Application No. PCT/CN2023/081349, filed on Mar. 14, 2023, which claims priority to Chinese Patent Application No. 202210420215.3, filed on Apr. 20, 2022. The entire disclosure of both applications is hereby incorporated by reference herein.

### FIELD

This application relates to the technical field of metal heating materials, and specifically, to a metal heating film, and a preparation method and use thereof.

### BACKGROUND

Electronic cigarettes are electronic products that mimic cigarettes. The electronic cigarettes have the same look, smoke, flavor, and feel as the cigarettes, but without tar. The electronic cigarette is a product that allows users to smoke by turning nicotine and other substances into vapor through atomization or by other means.

An atomization core of an electronic cigarette is the core component of the electronic cigarette, which plays a vital role in the taste, smoke amount, and other properties of the electronic cigarette. The atomization core of the electronic cigarette has experienced upgrading from glass fiber and cotton to porous cellular ceramic. The atomization core made of glass fiber provides poor taste with a small smoke amount. The cotton core still has shortcomings such as a short service life, a burnt core, and liquid leakage, although has improved in the taste and smoke amount. The ceramic atomization core not only provides good taste with no burnt core or explosion, but also has a long service life, especially with the use of a better oleophilic heating film instead of a heating wire to heat e-liquid, which increases a contact area of the heating element and the e-liquid, further improving atomization efficiency and taste.

However, the current heating film of the ceramic atomization core for the electronic cigarette is mostly made of a nickel-chromium alloy. Due to the effect of high-temperature corrosion by the e-liquid, at the e-liquid atomization temperature, the conventional nickel-chromium heating film leads to a very small amount of Ni and Cr elements into the smoke. To further improve smoke safety, the content of the Ni and Cr elements in the smoke needs to be further reduced, so as to avoid the harm to the body caused by the Ni and Cr elements in the smoke and ensure smoking safety of users.

In view of this, it is urgent to develop a metal heating film that can further reduce the content of the Ni and Cr elements in the smoke, and a preparation method thereof.

### SUMMARY

In an embodiment, the present invention provides a metal heating film, comprising: a nickel-chromium-alloy-based metal heating film or a nickel-based metal heating film; and at least one of metal elements Ru, Pt, and Pd.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a picture of a heating film according to Example 1 of this application after a cracking test;

FIG. 2 is a picture of a heating film according to Example 2 of this application after a cracking test;

FIG. 3 is a picture of a heating film according to Example 3 of this application after a cracking test;

FIG. 4 is a picture of a heating film according to Example 4 of this application after a cracking test;

FIG. 5 is a picture of a heating film according to Example 5 of this application after a cracking test;

FIG. 6 is a picture of a heating film according to Example 6 of this application after a cracking test;

FIG. 7 is a picture of a heating film according to Example 7 of this application after a cracking test; and

FIG. 8 is a picture of a heating film according to Comparative Example 1 of this application after a cracking test.

### DETAILED DESCRIPTION

In an embodiment, the present invention overcomes the defect in the related art that the content of the Ni and Cr elements in the smoke needs to be further reduced. In this case, a metal heating film, and a preparation method and use thereof are provided.

For this purpose, this application provides the following technical solutions:

This application provides a metal heating film. The metal heating film is a nickel-chromium-alloy-based metal heating film or a nickel-based metal heating film, and further includes at least one of metal elements Ru, Pt, and Pd.

Optionally, in percentage by mass of the metal heating film, the content of Ru is 0-24%, the content of Pt is 0-21%, and the content of Pd is 0-19%, and the three metal elements Ru, Pt, and Pd are not all 0; and optionally, all the three metal elements Ru, Pt, and Pd exist.

Optionally, in percentage by mass of the metal heating film, the content of Ni is 24-55%, and the content of Cr is 0-23%.

Optionally, in percentage by mass of the metal heating film, the metal heating film further includes 0-18% of Fe, 0-4% of Nb, 0-3% of Mn, 0-2% of Mo, 0-2% of W, and 0-2.5% of Si.

This application further provides a method for preparing a metal heating film, including the following steps:
mixing 60-90% of metal component, 0.5-9% of glass powder, and 8-40% of organic carrier in percentage by mass of a raw material, to obtain a paste; and
coating a substrate with the paste, prior to drying and sintering, to obtain the metal heating film, where
in percentage by mass of the metal component and the glass powder, the metal heating film includes 24-55% of Ni, 0-23% of Cr, 0-18% of Fe, 0-24% of Ru, 0-21% of Pt, 0-19% of Pd, 0-4% of Nb, 0-3% of Mn, 0-2% of Mo, 0-2% of W, and 0-6% of Si, and the three metal elements Ru, Pt, and Pd are not all 0.

Optionally, the method further includes the step of preparing the metal component into metal powder: weighing all parts of the metal component in proportion, prior to mixing, melting, and atomizing, to obtain the metal powder.

Optionally, a temperature for melting the metal component is 1400-1600° C.

Optionally, the metal component without Ru, Pt, and Pd is prepared into metal powder.

Optionally, the method for preparing the metal heating film meets at least one of the following (1) to (11):
(1) In percentage by mass of the glass powder, the glass powder includes: 30-73% of silicon oxide, 2-23% of boron oxide, 0.5-8% of aluminum oxide, 0-7% of calcium oxide, 4-12% of zinc oxide, 0-5% of magnesium oxide, 1-5% of titanium oxide, 0-11% of sodium oxide, 0-3% of potassium oxide, and 0.2-4% of zirconium oxide.
(2) In percentage by mass of the metal component and the glass powder, 0-2% of B, 0-1% of Al, 0-1% of Ca, 0-1.5% of Zn, 0-1% of Mg, 0-0.5% of Ti, 0-1.5% of Na, 0-0.5% of K, and 0-0.5% of Zr are further included.
(3) A method for preparing the glass powder includes: mixing required oxides in proportion, prior to melting, water quenching, and grinding, to obtain the glass powder.

Optionally, a temperature for melting the glass powder is 1450-1550° C.
(4) The particle size of the glass powder is 1-15 μm.
(5) The organic carrier is a mixture of ethyl cellulose, acrylic resin, tributyl citrate, terpineol, butyl carbitol, and butyl carbitol acetate.

Optionally, a mass ratio of ethyl cellulose to acrylic resin to tributyl citrate to terpineol to butyl carbitol to butyl carbitol acetate in the organic carrier is 1:(0.1-0.3):(0.4-0.6):(7-9):(6-9):(3-5).

Optionally, the organic carrier may be mixed under heat at a heating temperature of 75-90° C.
(6) The substrate is coated with the paste through screen printing.
(7) The substrate is a ceramic substrate.
(8) A temperature for the drying is 100-300° C.
(9) A temperature for the sintering is 800-1500° C.
(10) Time for the sintering is 0.5-3 h.
(11) An atmosphere for the sintering is a vacuum, nitrogen, or argon atmosphere.

This application further provides an electronic cigarette atomization core, including the foregoing metal heating film or the metal heating film prepared by using the foregoing preparation method.

This application further provides an electronic cigarette, including the foregoing electronic cigarette atomization core.

This application does not specifically limit other structures and preparation methods of the electronic cigarette atomization core and the electronic cigarette. The main improvement is the use of the metal heating film provided in this application or the metal heating film prepared by using the foregoing method.

The nickel-chromium-alloy-based metal heating film or nickel-based metal heating film in this application is an alloy obtained by doping other metal components in the nickel-chromium alloy or the nickel metal.

The technical solutions of this application have the following advantages:

This application provides a metal heating film. The metal heating film is a nickel-chromium-alloy-based metal heating film or a nickel-based metal heating film, and further includes at least one of metal elements Ru, Pt, and Pd. In this application, at least one of elements Ru, Pt, and Pd is introduced into a nickel-chromium alloy or a nickel metal to form an alloy with the nickel-chromium alloy or the nickel metal, improving the resistance of the obtained metal heating film to high-temperature corrosion by e-liquid, and reducing the content of Ni, Cr, and other elements in smoke. In addition, after the introduction of the elements Ru, Pt, and Pd, these elements can form the alloy with Ni, Cr, and other elements, which helps melting. In this case, the sintered heating film is denser and more resistant to thermal shocks of the e-liquid, and the heating film is less likely to crack and fail during smoking. Moreover, these elements have a modifying effect on the microstructure of the surface of the heating film, so that various components in the e-liquid can be atomized in a more coordinated manner, leading to better consistency in taste.

The content of each component in the metal heating film provided in this application is limited, which can further improve the resistance of the metal heating film to high-temperature corrosion by e-liquid. In particular, when all the metal elements Ru, Pt, and Pd exist, the resistance of the metal heating film to high-temperature corrosion by e-liquid is optimal, and the content of Ni, Cr, and other elements in smoke is minimum.

By using the method for preparing the metal heating film provided in this application, Ru, Pt, Pd, or other elements can be introduced into a nickel-chromium alloy or a nickel metal to form an alloy with the nickel-chromium alloy, improving the resistance of the obtained metal heating film to high-temperature corrosion by e-liquid, and reducing the content of Ni, Cr, and other elements in smoke. In addition, these elements can further help melting. In this case, the sintered heating film is denser and more resistant to thermal shocks of the e-liquid, and the heating film is less likely to crack and fail during smoking. Moreover, these elements have a modifying effect on the microstructure of the surface of the heating film, so that various components in the e-liquid can be atomized in a more coordinated manner, leading to better consistency in taste.

In the method for preparing the metal heating film provided in this application, by further limiting the preparation steps, the metal component without Ru, Pt, and Pd is prepared into metal powder. In this way, the elements Ru, Pt, and Pd can be introduced into a nickel-based alloy or a nickel metal, so that these highly corrosion-resistant metals are concentrated on the surface of the metal powder to finally form a structure of the heating film with a low content of the elements Ru, Pt, and Pd inside and a high content of the elements Ru, Pt, and Pd outside, which can further improve the resistance of the heating film to corrosion. In addition, in this case, Ru, Pt, and Pd cover the surface of the heating film. When the content of Ru, Pt, and Pd is close to the content of Ni and Cr in the smoke, the demand for the elements Ru, Pt, and Pd is low, reducing economic costs.

The following examples are provided for a better and further understanding of this application, are not limited to optimal implementations, and do not constitute a limitation on the content and protection scope of this application. Any product same as or similar to this application derived by any person under the inspiration of this application or by combining features of this application and other existing technologies falls within the protection scope of this application.

Steps in the examples for which specific experimental steps or conditions are not indicated are performed according to operations or conditions of conventional experimental steps described in documents in the art. Reagents or instruments used with no indication of manufacturers are conventional reagent products that are commercially available.

### Example 1

This example provides a metal heating film and a preparation method thereof, specifically as follows:

A raw material consists of 80 wt % of metal component, 5 wt % of glass powder, and 15% of organic carrier.

The metal component consists of 65 wt % of Ni, 10 wt % of Cr, 5 wt % of Fe, 5 wt % of Ru, 2 wt % of Pt, 3 wt % of Pd, 2 wt % of Nb, 3 wt % of Mn, 3 wt % of Mo, 1 wt % of W, and 1 wt % of Si.

The glass powder consists of 65% of silicon oxide, 5% of boron oxide, 8% of aluminum oxide, 7% of calcium oxide, 6% of zinc oxide, 3% of magnesium oxide, 1% of titanium oxide, 4% of sodium oxide, 0.5% of potassium oxide, and 0.5% of zirconium oxide.

Method for preparing the heating film:

Preparation of metal powder: The purchased Ni, Cr, Fe, Ru, Pt, Pd, Nb, Mn, Mo, W, and Si materials were mixed in the foregoing proportions, melted at 1500° C., and then atomized in nitrogen to prepare the metal powder, with an injection angle α=46°, an extension length of a liquid guiding tube z=2 mm, and an inner diameter of the liquid guiding tube d=4 mm, for use.

Preparation of the glass powder: The required oxides were weighed in the foregoing proportions, mixed uniformly, placed in an aluminum oxide crucible, heated to 1520° C. until melted, and poured into deionized water for water quenching into glass crumbs, and then the glass crumbs were crushed by mechanical ball milling to 1-15 μm, for use.

Organic carrier: Ethyl cellulose (manufacturer: SINOPHARM, model: EC200), acrylic resin (manufacturer: SINOPHARM, model: 4086), tributyl citrate, terpineol, butyl carbitol, and butyl carbitol acetate (manufacturer: SINOPHARM) were weighed in a mass ratio of 1:0.2:0.5:8:7.5:4, placed in a beaker, and heated to 85° C. until completely dissolved, for use.

Preparation of a paste of the heating film: The metal powder, the glass powder, and the organic carrier were weighed in the required proportions, mixed uniformly, and prepared by using a three-roller mill into the paste of the heating film.

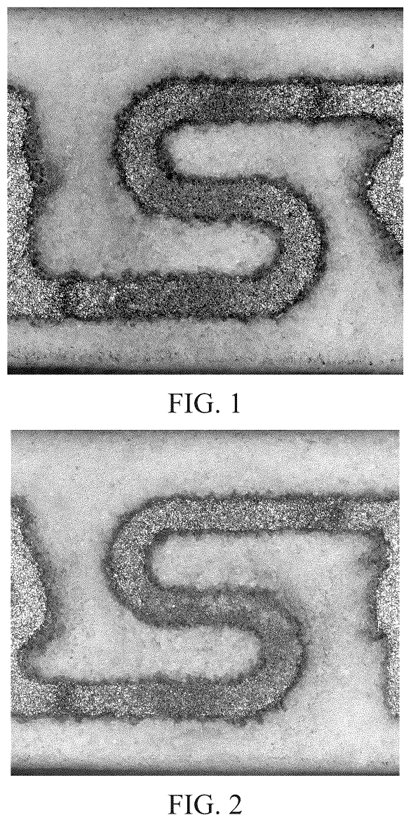

The paste of the heating film was printed on the surface of a ceramic substrate (manufacturer: SMOORE, AT02) through screen printing to prepare a heating film circuit with a pattern shown in FIG. 1 in 9 mm×3.5 mm. The ceramic substrate with the paste printed was dried at 200° C. and then sintered at 1200° C. for 2 h to form a ceramic substrate heating film.

### Example 2

This example provides a metal heating film and a preparation method thereof, specifically as follows:

A raw material consists of 60 wt % of metal component 1, 26 wt % of metal component 2, 6 wt % of glass powder, and 8% of organic carrier.

The metal component 1 consists of 85 wt % of Ni and 15 wt % of Cr.

The metal component 2 consists of 100 wt % of Ru powder.

The glass powder consists of 67% of silicon oxide, 8% of boron oxide, 3% of aluminum oxide, 5% of calcium oxide, 7% of zinc oxide, 3% of magnesium oxide, 2% of titanium oxide, 3% of sodium oxide, 1% of potassium oxide, and 1% of zirconium oxide.

Method for preparing the heating film:

Preparation of metal powder 1: The purchased Ni and Cr materials were mixed in the foregoing proportions, melted at 1500° C., and then atomized in nitrogen to prepare the metal powder, with an injection angle α=46°, an extension length of a liquid guiding tube z=2 mm, and an inner diameter of the liquid guiding tube d=4 mm, for use.

Preparation of the glass powder: The required oxides were weighed in the foregoing proportions, mixed uniformly, placed in an aluminum oxide crucible, heated to 1480° C. until melted, and poured into deionized water for water quenching into glass crumbs, and then the glass crumbs were crushed by mechanical ball milling to 1-15 μm, for use.

Organic carrier: Ethyl cellulose (manufacturer: SINOPHARM, model: EC200), acrylic resin (manufacturer: SINOPHARM, model: 4086), tributyl citrate, terpineol, butyl carbitol, and butyl carbitol acetate (manufacturer: SINOPHARM) were weighed in a mass ratio of 1:0.2:0.5:8:7.5:4, placed in a beaker, and heated to 80° C. until completely dissolved, for use.

Preparation of a paste of the heating film: The metal powder 1, the metal component 2, the glass powder, and the organic carrier were weighed in the required proportions, mixed uniformly, and prepared by using a three-roller mill into the paste of the heating film.

The paste of the heating film was printed on the surface of a ceramic substrate (manufacturer: SMOORE, AT02) through screen printing to prepare a heating film circuit with a pattern shown in FIG. 2 in 9 mm×3.5 mm. The ceramic substrate with the paste printed was dried at 160° C. and then sintered at 1250° C. for 2 h to form a ceramic substrate heating film.

### Example 3

This example provides a metal heating film and a preparation method thereof, specifically as follows:

A raw material consists of 65 wt % of metal component 1, 16 wt % of metal component 2, 5 wt % of glass powder, and 14% of organic carrier.

The metal component 1 consists of 100 wt % of Ni.

The metal component 2 consists of 100 wt % of Pt powder.

The glass powder consists of 55% of silicon oxide, 18% of boron oxide, 3% of aluminum oxide, 6% of calcium oxide, 10% of zinc oxide, 3% of magnesium oxide, 1% of titanium oxide, 3% of sodium oxide, 0.5% of potassium oxide, and 0.5% of zirconium oxide.

Method for preparing the heating film:

Preparation of metal powder 1: The purchased Ni material was mixed in the foregoing proportion, melted at 1500° C., and then atomized in nitrogen to prepare the metal powder, with an injection angle α=46°, an extension length of a liquid guiding tube z=2 mm, and an inner diameter of the liquid guiding tube d=4 mm, for use.

Preparation of the glass powder: The required oxides were weighed in the foregoing proportions, mixed uniformly, placed in an aluminum oxide crucible, heated to 1450° C. until melted, and poured into deionized water for water quenching into glass crumbs, and then the glass crumbs were crushed by mechanical ball milling to 1-15 μm, for use.

Organic carrier: Ethyl cellulose (manufacturer: SINOPHARM, model: EC200), acrylic resin (manufacturer: SINOPHARM, model: 4086), tributyl citrate, terpineol, butyl carbitol, and butyl carbitol acetate (manufacturer: SINOPHARM) were weighed in a mass ratio of 1:0.2:0.5:8:7.5:4, placed in a beaker, and heated to 75° C. until completely dissolved, for use.

Preparation of a paste of the heating film: The metal powder 1, the metal component 2, the glass powder, and the organic carrier were weighed in the required proportions, mixed uniformly, and prepared by using a three-roller mill into the paste of the heating film.

The paste of the heating film was printed on the surface of a ceramic substrate (manufacturer: SMOORE, AT02) through screen printing to prepare a heating film circuit with a pattern shown in FIG. 3 in 9 mm×3.5 mm. The ceramic substrate with the paste printed was dried at 160° C. and then sintered at 1150° C. for 0.5 h to form a ceramic substrate heating film.

### Example 4

This example provides a metal heating film and a preparation method thereof, specifically as follows:

A raw material consists of 60 wt % of metal component 1, 15.2 wt % of metal component 2, 4.8 wt % of glass powder, and 20% of organic carrier.

The metal component 1 consists of 85 wt % of Ni and 15% of Cr.

The metal component 2 consists of 100 wt % of Pt powder.

The glass powder consists of 46% of silicon oxide, 20% of boron oxide, 3% of aluminum oxide, 6% of calcium oxide, 11% of zinc oxide, 4% of magnesium oxide, 3% of titanium oxide, 3% of sodium oxide, 2% of potassium oxide, and 2% of zirconium oxide.

Method for preparing the heating film:

Preparation of metal powder 1: The purchased Ni and Cr materials were mixed in the foregoing proportions, melted at 1500° C., and then atomized in nitrogen to prepare the metal powder, with an injection angle α=46°, an extension length of a liquid guiding tube z=2 mm, and an inner diameter of the liquid guiding tube d=4 mm, for use.

Preparation of the glass powder: The required oxides were weighed in the foregoing proportions, mixed uniformly, placed in an aluminum oxide crucible, heated to 1480° C. until melted, and poured into deionized water for water quenching into glass crumbs, and then the glass crumbs were crushed by mechanical ball milling to 1-15 μm, for use.

Organic carrier: Ethyl cellulose (manufacturer: SINOPHARM, model: EC200), acrylic resin (manufacturer: SINOPHARM, model: 4086), tributyl citrate, terpineol, butyl carbitol, and butyl carbitol acetate (manufacturer: SINOPHARM) were weighed in a mass ratio of 1:0.2:0.5:8:7.5:4, placed in a beaker, and heated to 88° C. until completely dissolved, for use.

Preparation of a paste of the heating film: The metal powder 1, the metal component 2, the glass powder, and the organic carrier were weighed in the required proportions, mixed uniformly, and prepared by using a three-roller mill into the paste of the heating film.

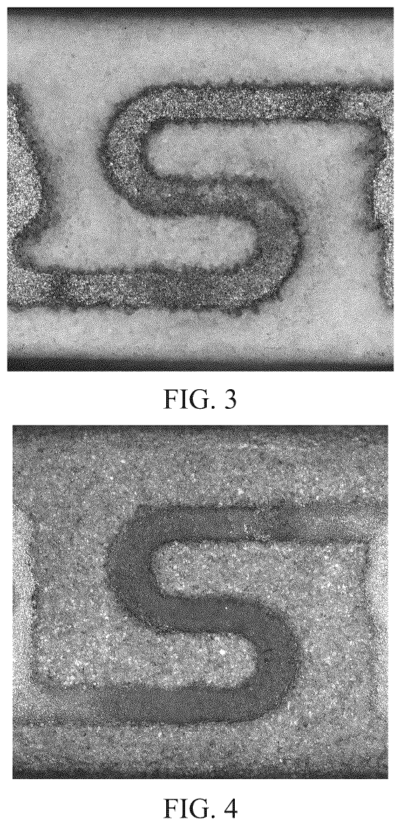

The paste of the heating film was printed on the surface of a ceramic substrate (manufacturer: SMOORE, AT02) through screen printing to prepare a heating film circuit with a pattern shown in FIG. 4 in 9 mm×3.5 mm. The ceramic substrate with the paste printed was dried at 100° C. and then sintered at 1000° C. for 3 h to form a ceramic substrate heating film.

### Example 5

This example provides a metal heating film and a preparation method thereof, specifically as follows:

A raw material consists of 72 wt % of metal component 1, 9 wt % of metal component 2, 9 wt % of glass powder, and 10% of organic carrier.

The metal component 1 consists of 85 wt % of Ni and 15 wt % of Cr.

The metal component 2 consists of 100 wt % of Pd powder.

The glass powder consists of 70% of silicon oxide, 8% of boron oxide, 2% of aluminum oxide, 1% of calcium oxide, 8% of zinc oxide, 2% of magnesium oxide, 3% of titanium oxide, 4% of sodium oxide, 1% of potassium oxide, and 1% of zirconium oxide.

Method for preparing the heating film:

Preparation of metal powder 1: The purchased Ni and Cr materials were mixed in the foregoing proportions, melted at 1500° C., and then atomized in nitrogen to prepare the metal powder, with an injection angle α=46°, an extension length of a liquid guiding tube z=2 mm, and an inner diameter of the liquid guiding tube d=4 mm, for use.

Preparation of the glass powder: The required oxides were weighed in the foregoing proportions, mixed uniformly, placed in an aluminum oxide crucible, heated to 1480° C. until melted, and poured into deionized water for water quenching into glass crumbs, and then the glass crumbs were crushed by mechanical ball milling to 1-15 μm, for use.

Organic carrier: Ethyl cellulose (manufacturer: SINOPHARM, model: EC200), acrylic resin (manufacturer: SINOPHARM, model: 4086), tributyl citrate, terpineol, butyl carbitol, and butyl carbitol acetate (manufacturer: SINOPHARM) were weighed in a mass ratio of 1:0.2:0.5:8:7.5:4, placed in a beaker, and heated to 75° C. until completely dissolved, for use.

Preparation of a paste of the heating film: The metal powder 1, the metal component 2, the glass powder, and the organic carrier were weighed in the required proportions, mixed uniformly, and prepared by using a three-roller mill into the paste of the heating film.

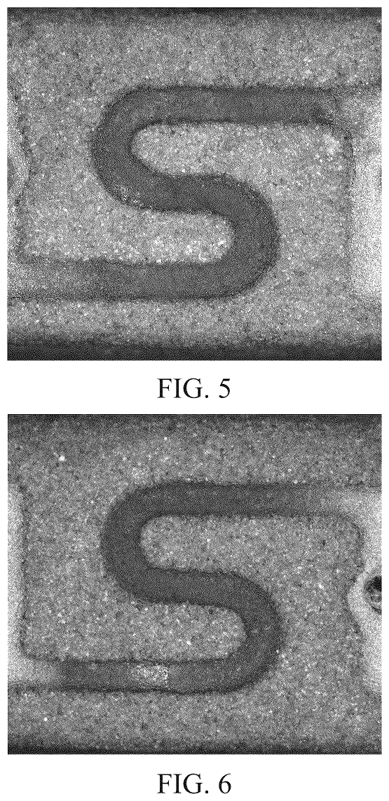

The paste of the heating film was printed on the surface of a ceramic substrate (manufacturer: SMOORE, AT02) through screen printing to prepare a heating film circuit with a pattern shown in FIG. 5 in 9 mm×3.5 mm. The ceramic substrate with the paste printed was dried at 120° C. and then sintered at 1050° C. for 2.5 h to form a ceramic substrate heating film.

### Example 6

This example provides a metal heating film and a preparation method thereof, specifically as follows:

A raw material consists of 72 wt % of metal component 1, 9 wt % of metal component 2, 9 wt % of glass powder, and 10% of organic carrier.

The metal component 1 consists of 85 wt % of Ni and 15 wt % of Cr.

The metal component 2 consists of 30 wt % of Ru powder, 35% of Pt powder, and 35 wt % of Pd powder.

The glass powder consists of 70% of silicon oxide, 8% of boron oxide, 2% of aluminum oxide, 1% of calcium oxide, 8% of zinc oxide, 2% of magnesium oxide, 3% of titanium oxide, 4% of sodium oxide, 1% of potassium oxide, and 1% of zirconium oxide.

Method for preparing the heating film:

Preparation of metal powder 1: The purchased Ni and Cr materials were mixed in the foregoing proportions, melted at 1500° C., and then atomized in nitrogen to prepare the metal powder, with an injection angle α=46°, an extension length of a liquid guiding tube z=2 mm, and an inner diameter of the liquid guiding tube d=4 mm, for use.

Metal powder 2 was provided by Hunan Rhenium Alloy Material Co., Ltd.

Preparation of the glass powder: The required oxides were weighed in the foregoing proportions, mixed uniformly, placed in an aluminum oxide crucible, heated to 1480° C. until melted, and poured into deionized water for water quenching into glass crumbs, and then the glass crumbs were crushed by mechanical ball milling to 1-15 μm, for use.

Organic carrier: Ethyl cellulose (manufacturer: SINOPHARM, model: EC200), acrylic resin (manufacturer: SINOPHARM, model: 4086), tributyl citrate, terpineol, butyl carbitol, and butyl carbitol acetate (manufacturer: SINOPHARM) were weighed in a mass ratio of 1:0.2:0.5:8:7.5:4, placed in a beaker, and heated to 75° C. until completely dissolved, for use.

Preparation of a paste of the heating film: The metal powder 1, the metal powder 2, the glass powder, and the organic carrier were weighed in the required proportions, mixed uniformly, and prepared by using a three-roller mill into the paste of the heating film.

The paste of the heating film was printed on the surface of a ceramic substrate (manufacturer: SMOORE, AT02) through screen printing to prepare a heating film circuit with a pattern shown in FIG. 6 in 9 mm×3.5 mm. The ceramic substrate with the paste printed was dried at 120° C. and then sintered at 1050° C. for 2.5 h to form a ceramic substrate heating film.

### Example 7

This example provides a metal heating film and a preparation method thereof, specifically as follows:

A raw material consists of 80 wt % of metal component, 5 wt % of glass powder, and 15 wt % of organic carrier.

The metal component consists of 65 wt % of Ni, 10 wt % of Cr, 5 wt % of Fe, 5 wt % of Ru, 2 wt % of Pt, 3 wt % of Pd, 2 wt % of Nb, 3 wt % of Mn, 3 wt % of Mo, 1 wt % of W, and 1 wt % of Si.

The glass powder consists of 65% of silicon oxide, 5% of boron oxide, 8% of aluminum oxide, 7% of calcium oxide, 6% of zinc oxide, 3% of magnesium oxide, 1% of titanium oxide, 4% of sodium oxide, 0.5% of potassium oxide, and 0.5% of zirconium oxide.

Method for preparing the heating film:

Preparation of metal powder 1: The purchased Ni, Cr, Fe, Nb, Mn, Mo, W, and Si (except Ru and Pt) materials were mixed in the foregoing proportions, melted at 1500° C., and then atomized in nitrogen to prepare the metal powder, with an injection angle α=46°, an extension length of a liquid guiding tube z=2 mm, and an inner diameter of the liquid guiding tube d=4 mm, for use.

Preparation of the glass powder: The required oxides were weighed in the foregoing proportions, mixed uniformly, placed in an aluminum oxide crucible, heated to 1520° C. until melted, and poured into deionized water for water quenching into glass crumbs, and then the glass crumbs were crushed by mechanical ball milling to 1-15 μm, for use.

Organic carrier: Ethyl cellulose (manufacturer: SINOPHARM, model: EC200), acrylic resin (manufacturer: SINOPHARM, model: 4086), tributyl citrate, terpineol, butyl carbitol, and butyl carbitol acetate (manufacturer: SINOPHARM) were weighed in a mass ratio of 1:0.2:0.5:8:7.5:4, placed in a beaker, and heated to 82° C. until completely dissolved, for use.

Preparation of a paste of the heating film: The metal powder 1, the Ru powder, the Pt powder, the glass powder, and the organic carrier were weighed in the required proportions, mixed uniformly, and prepared by using a three-roller mill into the paste of the heating film.

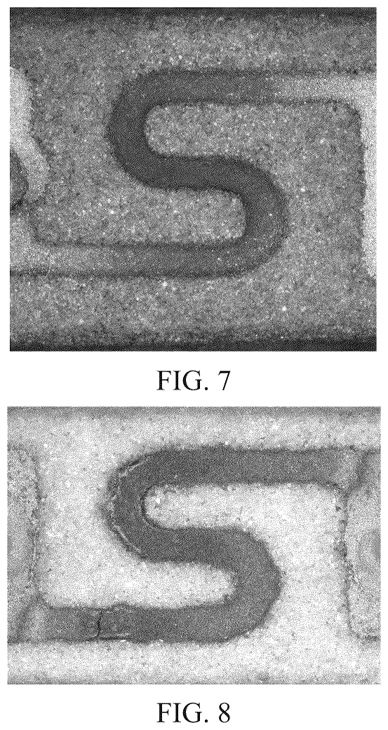

The paste of the heating film was printed on the surface of a ceramic substrate (manufacturer: SMOORE, AT02) through screen printing to prepare a heating film circuit with a pattern shown in FIG. 7 in 9 mm×3.5 mm. The ceramic substrate with the paste printed was dried at 120° C. and then sintered at 1200° C. for 2 h to form a ceramic substrate heating film.

### Comparative Example 1

This comparative example provides a metal heating film and a preparation method thereof, specifically as follows:

A raw material consists of 86 wt % of metal component, 6 wt % of glass powder, and 8% of organic carrier.

The metal component consists of 85 wt % of Ni and 15 wt % of Cr.

The glass powder consists of 67% of silicon oxide, 8% of boron oxide, 3% of aluminum oxide, 5% of calcium oxide, 7% of zinc oxide, 3% of magnesium oxide, 2% of titanium oxide, 3% of sodium oxide, 1% of potassium oxide, and 1% of zirconium oxide.

Method for preparing the heating film:

Preparation of metal powder: The purchased Ni and Cr materials were mixed in the foregoing proportions, melted at 1500° C., and then atomized in nitrogen to prepare the metal powder, with an injection angle α=46°, an extension length of a liquid guiding tube z=2 mm, and an inner diameter of the liquid guiding tube d=4 mm, for use.

Preparation of the glass powder: The required oxides were weighed in the foregoing proportions, mixed uniformly, placed in an aluminum oxide crucible, heated to 1480° C. until melted, and poured into deionized water for water quenching into glass crumbs, and then the glass crumbs were crushed by mechanical ball milling to 1-15 μm, for use.

Organic carrier: Ethyl cellulose (manufacturer: SINOPHARM, model: EC200), acrylic resin (manufacturer: SINOPHARM, model: 4086), tributyl citrate, terpineol, butyl carbitol, and butyl carbitol acetate (manufacturer: SINOPHARM) were weighed in a mass ratio of 1:0.2:0.5:8:7.5:4, placed in a beaker, and heated to 80° C. until completely dissolved, for use.

Preparation of a paste of the heating film: The metal powder, the glass powder, and the organic carrier were weighed in the required proportions, mixed uniformly, and prepared by using a three-roller mill into the paste of the heating film.

The paste of the heating film was printed on the surface of a ceramic substrate (manufacturer: SMOORE, AT02) through screen printing to prepare a heating film circuit with a pattern shown in FIG. 8 in 9 mm×3.5 mm. The ceramic substrate with the paste printed was dried at 160° C. and then sintered at 1250° C. for 2 h to form a ceramic substrate heating film.

### Test Examples

The metal heating films provided in the examples and comparative example of this application were tested by using specific testing methods as follows:

Smoke composition test: Electronic cigarette aerogel was collected and analyzed for its composition by gas chromatography-mass spectrometry (GC-MS).

### Smoking Taste Experiment

The metal heating films provided in the examples and comparative example were tested with a power of 6.5 W in a blind evaluation manner. The e-liquid of the electronic cigarette was vaped by using a large circulation smoking method. The sensory evaluation was performed by a smoking taste group consisting of five people respectively. The taste evaluation criterion is shown in the table below, mainly including the following evaluation indexes: an aroma concentration, irritation (impurity gas), a smoke amount, sweetness, a throat hit, smoke humidity, harmonization, and satisfaction. The maximum score for each evaluation index is 10 points, and each evaluation index is scored by 0.5 points.

The meanings of the eight evaluation indexes are as follows: Aroma concentration: the degree of thickness of the overall smoke for the nose and mouth. Irritation: the sensory perception of irritation in the mouth, throat, and nose from the smoke of the atomized e-liquid, for example, the feeling of particles, pins and needles, as well as impurity gas. Smoke amount: the total amount of aerosol formed through the atomization of the e-liquid, and the amount of the smoke perceived through the mouth and visually seen after exhaling. Sweetness: the degree of sweetness of the atomized e-liquid perceived in the mouth and the degree of sweetness of the atomized e-liquid perceived in the nose. Throat hit: the physical sensory intensity of the hit of the smoke of the inhaled aerosol on the throat. Smoke humidity: the degree of dryness/wetness of the smoke particle and droplet molecules perceived by the mouth and nose. Harmonization: the degree of mixing uniformity and harmony of the aroma of the atomized e-liquid. Satisfaction: the feeling of short-term brain excitement in response to the absorption of nicotine by the lungs by taking the same number of puffs on the electronic cigarette, which may be numbness and dizziness in the head, and other symptoms.

TABLE 1
Evaluation criterion for sensory quality of e-liquid

| Aroma | | Smoke | | | Smoke | | |
|---|---|---|---|---|---|---|---|
| concentration | Irritation | amount | Sweetness | Throat hit | humidity | Harmonization | Satisfaction |
| Full and rich | None 10 | Large ≥8 | Strong | Large ≥8 | Wet 10 | Very good 10 | Strong |
| 10 | | | 10 | | | | 10 |
| Relatively full | Slightly | Relatively | Relatively | Relatively | Relatively | Good | Relatively |
| and rich | exists | large | strong | large | wet | 7.5-9.5 | strong |
| 7.5-9.5 | 9-9.5 | 6-7.5 | 7.5-9.5 | 6-7.5 | 7.5-9.5 | | 7.5-9.5 |
| Slightly full | Marginally | Moderate | Exists | Moderate | Slightly | Relatively | Exists |
| and rich | exists | 5-5.5 | 4.5-7 | 4.5-5.5 | wet | good | 4.5-7 |
| 5.5-7 | 8-8.5 | | | | 5.5-7 | 5.5-7 | |
| Faint aroma, | Exists 7-7.5 | Relatively | Marginally | Relatively | Not | Moderate | Marginally |
| not full ≤5 | | small | exists | small | wet ≤5 | 4.5-5 | exists |
| | | 2.5-4.5 | 2.5-4 | 2.5-4 | | | 2.5-4 |
| | Relatively | Small ≤2 | Slightly | Small ≤2 | | Relatively poor | Slightly |
| | strong | | exists | | | 2.5-4 | exists |
| | 5.5-6.5 | | 0.5-2 | | | | 0.5-2 |
| | Strong ≤5 | | None 0 | | | Poor ≤2 | None 0 |

### Cracking Test Method and Steps:

Cracking test solution: The heating film was subjected to a power-on test with a power of 6.5 W and power-on time of 3s, for 40 times, and the crack of the heating film was observed, as shown in FIG. 1 to FIG. 8. As can be seen from the figures, the heating film provided in Comparative Example 1 cracks after the cracking test, a crack exists in the lower left side in FIG. 8 while no crack exists in Examples 1 to 7, and the lower left sides in FIG. 1 to FIG. 3 are only deepened in color without cracks.

The specific test results are shown in the following table:

TABLE 2

| | Solution | | | | | |
|---|---|---|---|---|---|---|
| | Ni | As | Cr | Pb | Cd | Sb |
| | (ng/puff) | (ng/puff) | (ng/puff) | (ng/puff) | (ng/puff) | (ng/puff) |
| French | 25 | 2 | 3 | 5 | 2 | 20 |
| AFNOR | | | | | | |
| standard | | | | | | |
| RJR internal | 2.625 | / | 0.11 | / | / | / |
| standard | | | | | | |
| Comparative | 5.32 | ND | 0.48 | ND | ND | ND |
| Example 1 | | | | | | |
| Example 1 | 0.76 | ND | 0.08 | ND | ND | ND |
| Example 2 | 0.96 | ND | 0.07 | ND | ND | ND |
| Example 3 | 1.56 | ND | ND | ND | ND | ND |
| Example 4 | 1.15 | ND | 0.06 | ND | ND | ND |
| Example 5 | 1.21 | ND | 0.07 | ND | ND | ND |
| Example 6 | 0.52 | ND | 0.05 | ND | ND | ND |
| Example 7 | 0.62 | ND | 0.05 | ND | ND | ND |

Note: ND indicates below the lower test limit of the instrument.

TABLE 3

| | | | | | | | | | Total |
|---|---|---|---|---|---|---|---|---|---|
| | Aroma | | Smoke | | Throat | Smoke | | | taste |
| Number | concentration | Irritation | amount | Sweetness | hit | humidity | Harmonization | Satisfaction | score |
| Comparative | 6 | 6 | 6 | 3 | 6 | 6 | 7 | 7 | 47 |
| Example 1 | | | | | | | | | |
| Example 1 | 7 | 7 | 6 | 4 | 6 | 7 | 8 | 7 | 52 |
| Example 2 | 7 | 8 | 6 | 4 | 6 | 7 | 8 | 7 | 53 |
| Example 3 | 7 | 7 | 6 | 4 | 6 | 7 | 8 | 7 | 52 |
| Example 4 | 8 | 7 | 6 | 4 | 6 | 7 | 8 | 7 | 53 |
| Example 5 | 7 | 7 | 6 | 4 | 6 | 7 | 8 | 7 | 52 |
| Example 6 | 8 | 7 | 6 | 4 | 6 | 7 | 8 | 7 | 53 |
| Example 7 | 8 | 7 | 6 | 4 | 6 | 7 | 8 | 7 | 53 |

Note: The e-liquid used for testing is provided by American Tobacco Company, with a model number of BAT-204567.

It can be learned from the foregoing test results that, in the examples of this application, at least one of elements Ru, Pt, and Pd is introduced into a nickel-chromium alloy, improving the resistance of the obtained metal heating film to high-temperature corrosion by e-liquid, and reducing the content of Ni, Cr, and other elements in smoke. In addition, the heating film is less likely to crack and fail during smoking. Moreover, these elements have a modifying effect on the microstructure of the surface of the heating film, so that various components in the e-liquid can be atomized in a more coordinated manner, leading to better consistency in taste. It can be learned through comparison between the data of Example 6 and the data of Example 5 that, when all the metal elements Ru, Pt, and Pd exist in Example 6, the resistance of the metal heating film to high-temperature corrosion by e-liquid is optimal, and the content of Ni, Cr, and other elements in smoke is minimum.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A metal heating film, comprising:
a nickel-chromium-alloy-based metal heating film or a nickel-based metal heating film; and
at least one of metal elements Ru, Pt, and Pd.

2. The metal heating film of claim 1, wherein, in percentage by mass of the metal heating film, a content of Ru is 0-24%, a content of Pt is 0-21%, and a content of Pd is 0-19%, and the three metal elements Ru, Pt, and Pd are not all 0.

3. The metal heating film of claim 1, wherein, in percentage by mass of the metal heating film, a content of Ni is 24-55% and a content of Cr is 0-23%.

4. The metal heating film of claim 3, wherein, in percentage by mass of the metal heating film, the metal heating film further comprises:
0-18% of Fe,
0-4% of Nb,
0-3% of Mn,
0-2% of Mo,
0-2% of W, and
0-2.5% of Si.

5. A method for preparing a metal heating film, comprising:
mixing 60-90% of metal component, 0.5-9% of glass powder, and 8-40% of organic carrier in percentage by mass of a raw material, to obtain a paste; and
prior to drying and sintering, coating a substrate with the paste to obtain the metal heating film,
wherein, in percentage by mass of the metal component and the glass powder, the metal heating film comprises:
24-55% of Ni,
0-23% of Cr,
0-18% of Fe,
0-24% of Ru,
0-21% of Pt,
0-19% of Pd,
0-4% of Nb,
0-3% of Mn,
0-2% of Mo,
0-2% of W, and
0-6% of Si, and
wherein the three metal elements Ru, Pt, and Pd are not all 0.

6. The method of claim 5, further comprising: preparing the metal component into metal powder by weighing all parts of the metal component in proportion, prior to mixing, melting, and atomizing, to obtain the metal powder.

7. The method of claim 6, further comprising:
preparing the metal component into metal powder without Ru, Pt, and Pd.

8. The method of claim 5, wherein at least one of (1) to (11) is met:
(1) in percentage by mass of the glass powder, the glass powder comprises: 30-73% of silicon oxide, 2-23% of boron oxide, 0.5-8% of aluminum oxide, 0-7% of calcium oxide, 4-12% of zinc oxide, 0-5% of magnesium oxide, 1-5% of titanium oxide, 0-11% of sodium oxide, 0-3% of potassium oxide, and 0.2-4% of zirconium oxide,
(2) in percentage by mass of the metal component and the glass powder, the metal component and the glass powder comprise 0-2% of B, 0-1% of Al, 0-1% of Ca, 0-1.5% of Zn, 0-1% of Mg, 0-0.5% of Ti, 0-1.5% of Na, 0-0.5% of K, and 0-0.5% of Zr,
(3) a method for preparing the glass powder comprises: mixing required oxides in proportion, prior to melting, water quenching, and grinding, to obtain the glass powder,
(4) a particle size of the glass powder is 1-15 μm
(5) the organic carrier comprises a mixture of ethyl cellulose, acrylic resin, tributyl citrate, terpineol, butyl carbitol, and butyl carbitol acetate,
(6) the substrate is coated with the paste through screen printing,
(7) the substrate comprises a ceramic substrate,
(8) a temperature for the drying is 100-300° C.,
(9) a temperature for the sintering is 800-1500° C.,
(10) a time for the sintering is 0.5-3 h, and
(11) an atmosphere for the sintering is a vacuum, nitrogen, or argon atmosphere.

9. An electronic cigarette atomization core, comprising:
the metal heating film of claim 1.

10. An electronic cigarette, comprising:
the electronic cigarette atomization core of claim 9.

11. The metal heating film of claim 2, wherein the metal heating film comprises Ru, Pt, and Pd.

12. An electronic cigarette atomization core, comprising:
the metal heating film prepared by the method of claim 5.
